(19) United States
(12) Patent Application Publication
(10) Pub. No.: US 2023/0208065 A1
(43) Pub. Date: Jun. 29, 2023

(54) CONNECTOR AND CONNECTOR DEVICE

(71) Applicant: SUMITOMO WIRING SYSTEMS, LTD., Mie (JP)

(72) Inventor: Yasushi OKAYASU, Mie (JP)

(21) Appl. No.: 18/082,192

(22) Filed: Dec. 15, 2022

(30) Foreign Application Priority Data
Dec. 28, 2021 (JP) 2021-214345

(51) Int. Cl. H01R 13/428

(52) U.S. Cl. CPC H01R 13/428

(57) ABSTRACT

A connector 10 is provided with a terminal 20 and a connector housing 40. The connector housing 40 includes a terminal accommodating portion 41 for accommodating the terminal 20 and a locking lance 50 for locking the terminal 20 accommodated in the terminal accommodating portion 41. A part of the terminal 20 around a terminal-side opening 28 is exposed through a second opening part 45 in a region including a locking projection 52 of the locking lance 50 when observed from front of the connector housing 40 along a front-rear direction. A front end of the locking lance 50 in the front-rear direction is located at the same position as or in front of that of the terminal 20 and located at the same position as or behind that of the terminal accommodating portion 41.

### CROSS-REFERENCE TO RELATED APPLICATIONS

This application is based on and claims priority from Japanese Patent Application No. 2021-214345, filed on Dec. 28, 2021, with the Japan Patent Office, the disclosure of which is incorporated herein in its entirety by reference.

### TECHNICAL FIELD

The present disclosure relates to a connector and a connector device.

### BACKGROUND

Japanese Patent Laid-open Publication No. H07-130419 discloses a connector in which a flexible locking piece cantilevered in a connector housing locks a terminal fitting accommodated in a terminal accommodation chamber of the connector housing. In the connector described in Japanese Patent Laid-open Publication No. H07-130419, an unlocking portion on a free end part of the flexible locking piece projects beyond a connection surface part to a mating connector housing. In this way, a locked state of the terminal fitting by the flexible locking piece is easily released.

### SUMMARY

However, since the unlocking portion on the free end part of the flexible locking piece projects beyond the connection surface part to the mating connector housing in the connector described in Japanese Patent Laid-open Publication No. H07-130419, there is a concern that the flexible locking piece is excessively deflected by the lock releasing portion being erroneously contacted.

Accordingly, it is aimed to provide a technique capable of suppressing excessive deflection of a locking lance of a connector.

The present disclosure is directed to a connector with a terminal including a connecting portion to be connected to a mating terminal, and a connector housing including a terminal accommodating portion for accommodating the terminal and a locking lance for locking the terminal accommodated in the terminal accommodating portion, a housing-side opening being formed in a front part of the terminal accommodating portion, the housing-side opening including a first opening part, a tab portion of the mating terminal being inserted into the first opening part, and a second opening part for receiving an unlocking operation of the locking lance, the locking lance including a locking projection, the connecting portion being formed with a terminal-side opening, the tab portion passed through the first opening part being inserted into the terminal-side opening, and a lock receiving portion to be locked by the locking projection, a part of the terminal around the terminal-side opening being exposed through the second opening part in a region including the locking projection when observed from front of the connector housing along a front-rear direction, and a front end of the locking lance in the front-rear direction being located at the same position as or in front of that of the terminal and located at the same position as or behind that of the terminal accommodating portion.

According to the present disclosure, it is possible to suppress excessive deflection of a locking lance of a connector.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view showing a connector according to an embodiment.

FIG. 2 is a front view of the connector according to the embodiment.

FIG. 3 is a section along of FIG. 2.

FIG. 4 is a section along IV-IV of FIG. 2.

FIG. 5 is a section along V-V of FIG. 2.

FIG. 6 is an enlarged view of a region A1 of FIG. 2.

FIG. 7 is an enlarged view of a region A2 of FIG. 3.

FIG. 8 is a perspective view showing a terminal.

FIG. 9 is a side view showing a connector device.

FIG. 10 is a view showing respective connection surfaces of the connector and a mating connector.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.

The connector of the present disclosure is as follows.

(1) The connector is provided with a terminal including a connecting portion to be connected to a mating terminal, and a connector housing including a terminal accommodating portion for accommodating the terminal and a locking lance for locking the terminal accommodated in the terminal accommodating portion, a housing-side opening being formed in a front part of the terminal accommodating portion, the housing-side opening including a first opening part, a tab portion of the mating terminal being inserted into the first opening part, and a second opening part for receiving an unlocking operation of the locking lance, the locking lance including a locking projection, the connecting portion being formed with a terminal-side opening, the tab portion passed through the first opening part being inserted into the terminal-side opening, and a lock receiving portion to be locked by the locking projection, a part of the terminal around the terminal-side opening being exposed through the second opening part in a region including the locking projection when observed from front of the connector housing along a front-rear direction, and a front end of the locking lance in the front-rear direction being located at the same position as or in front of that of the terminal and located at the same position as or behind that of the terminal accommodating portion. By locating the front end of the locking lance at the same position as or behind that of the terminal accommodating portion in the front-rear direction, it is suppressed that the locking lance projects further forward than the terminal accommodating portion and the locking lance is excessively deflected. Further, since the part of the terminal around the terminal-side opening is exposed in the region including the locking projection when observed from the front of the connector housing along the front-rear direction, the shape of a mold is simplified in the case of injection-molding the connector housing using the mold. In this case, by locating the front end of the locking lance at the same position as or in front of that of the terminal in the front-rear direction, a gap formed around the front end of the locking lance becomes smaller and touch on the terminal through this gap is suppressed.

(2) In the connector of (1), a positioning wall portion for covering the front end of the terminal from front while narrowing the housing-side opening may be provided on the front end of the terminal accommodating portion. In this way, the terminal is suppressed from coming out forward from the terminal accommodating portion through the housing-side opening by the positioning wall portion.

(3) In the connector of (2), the connecting portion may be provided by bending and deforming a conductive plate, the connecting portion may include a plate-like part extending in the front-rear direction, a resilient piece extending forward from a rear end of the plate-like part and to be brought into contact with the tab portion, and a protecting piece extending toward the terminal-side opening from a front end of the plate-like part, a tip part of the protecting piece may cover a front end of the resilient piece from front, and a base end part of the protecting piece may be exposed through the second opening part when observed from the front of the connector housing along the front-rear direction. In this way, when the tab portion of the mating terminal is inserted into the first opening part and the terminal-side opening, the contact of the tab portion with the front end of the resilient piece is suppressed by the protecting piece. Further, the contact of a member for unlocking the locking lance with the front end of the resilient piece at the time of unlocking the locking lance is suppressed by the projecting piece.

(4) In the connector of (3), the lock receiving portion may include a recess formed in the plate-like part, and the connecting portion may include a projecting piece projecting from a peripheral edge part of the recess, out of the plate-like part, and interposed between the locking projection and the resilient piece. In this way, the contact of the resilient piece with the locking projection is suppressed by the projecting piece.

(5) In the connector of (3) or (4), the positioning wall portion of the terminal accommodating portion may include a partition wall portion partitioning between the first opening part and the second opening part, and the partition wall portion may cover the tip part of the protecting piece from front. In this way, when the tab portion of the mating terminal is inserted through the first opening part and the terminal-side opening, the tab portion is less likely to be caught by peripheral edge parts of the first opening part and the terminal-side opening.

(6) In the connector of (5), a slope portion for guiding the tab portion toward inside of the first opening part may be provided on the peripheral edge part of the first opening part, out of the positioning wall portion, and the partition wall portion may have a part constituted only by the slope portion. In this way, the first opening part and the second opening part can be close to each other and the enlargement of the connector housing can be suppressed.

(7) In the connector of any one of (1) to (6), the connector housing may include a first terminal accommodating portion and a second terminal accommodating portion, a rear part of the first terminal accommodating portion and that of the second terminal accommodating portion may be connected to each other, a front part of the first terminal accommodating portion and that of the second terminal accommodating portion may be separated from each other, and the locking lance provided in the first terminal accommodating portion may be facing the second terminal accommodating portion. In this way, a wall for suppressing excessive deflection of the locking lance outside the locking lance is omitted in the first terminal accommodating portion, whereby the structure of the connector housing is simplified and the enlargement of the connector housing is suppressed.

(8) Further, a connector device of the present disclosure is provided with the connector of any one of (1) to (7) and a mating connector to be connected to the connector, the connector housing of the connector and a connector housing of the mating connector being facing each other in the front-rear direction in a connected state. In this way, the connector housing of the connector and the connector housing of the mating connector are connected without via a front mask, front retainer or the like, whereby the enlargement of the connector device is suppressed.

### Details of Embodiment of Present Disclosure

Specific examples of a connector and a connector device of the present disclosure are described below with reference to the drawings. Note that the present disclosure is not limited to these illustrations, but is represented by claims and intended to include all changes in the scope of claims and in the meaning and scope of equivalents.

### Embodiment

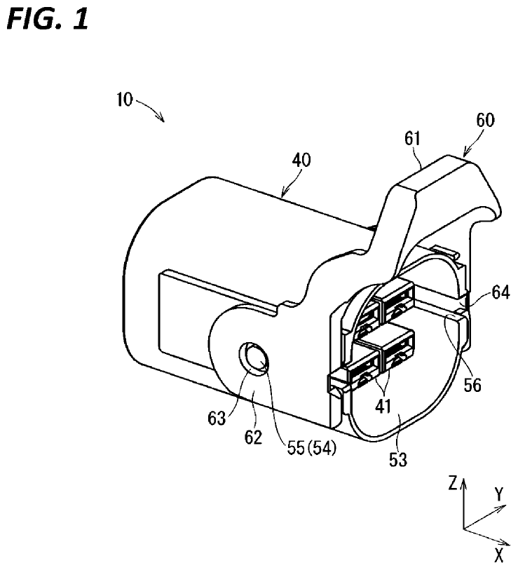

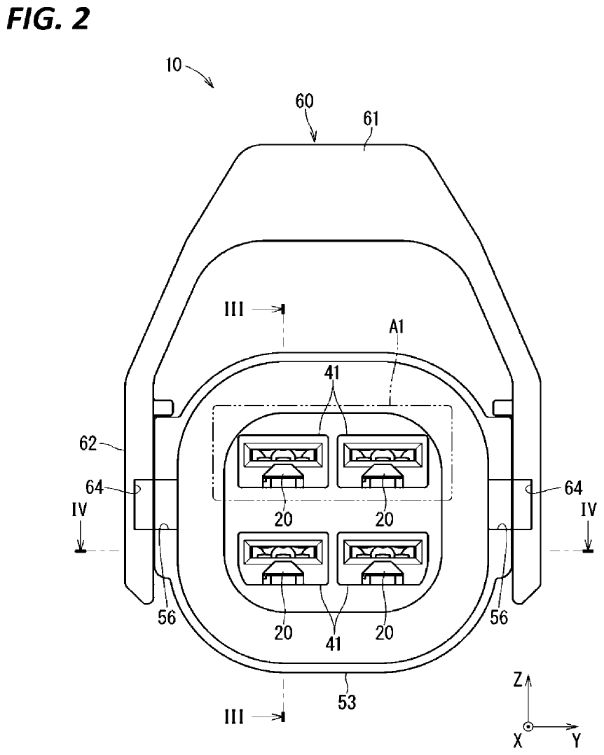

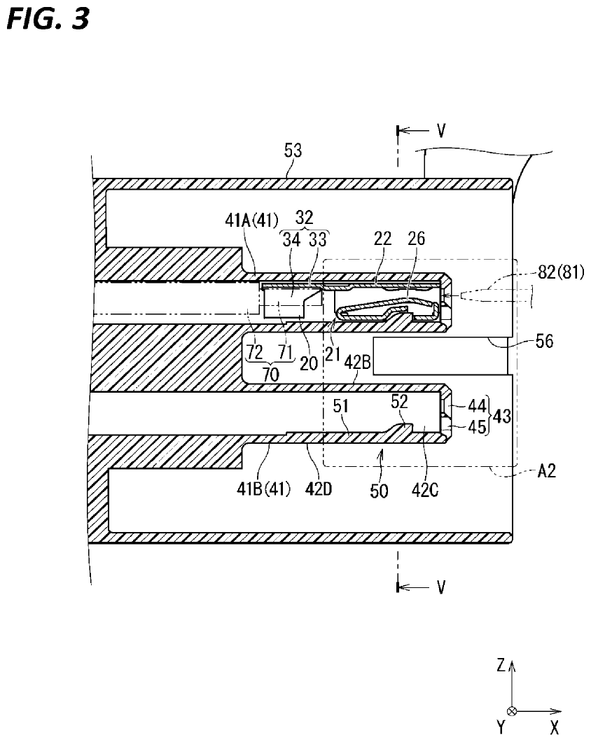

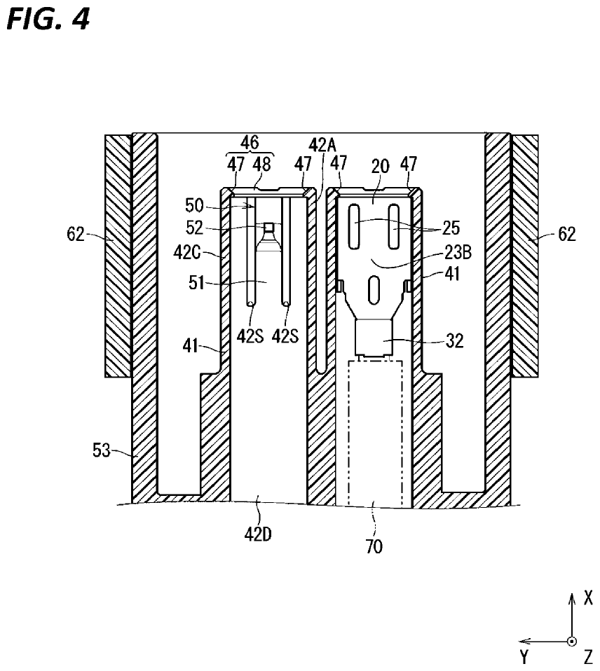

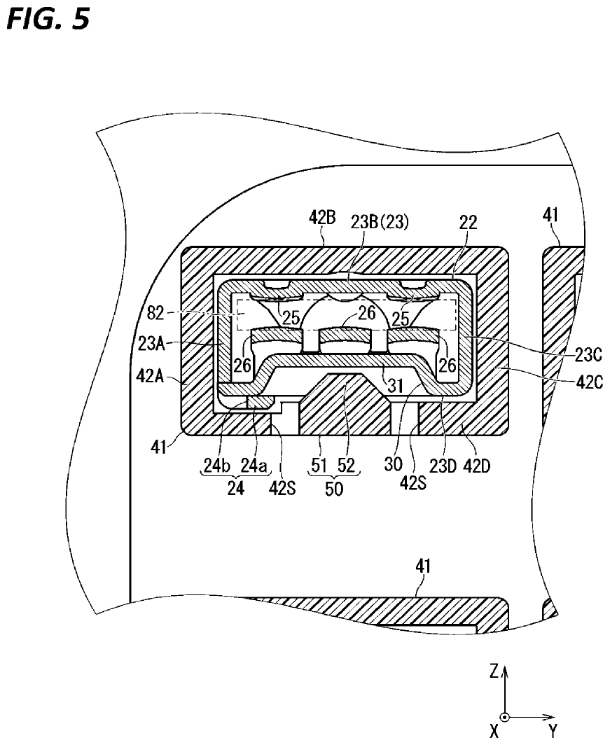

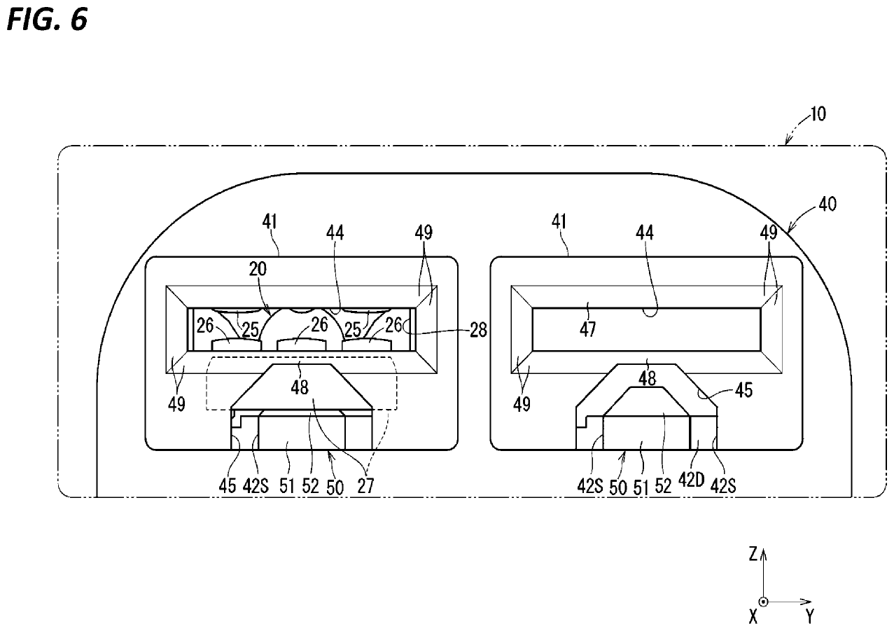

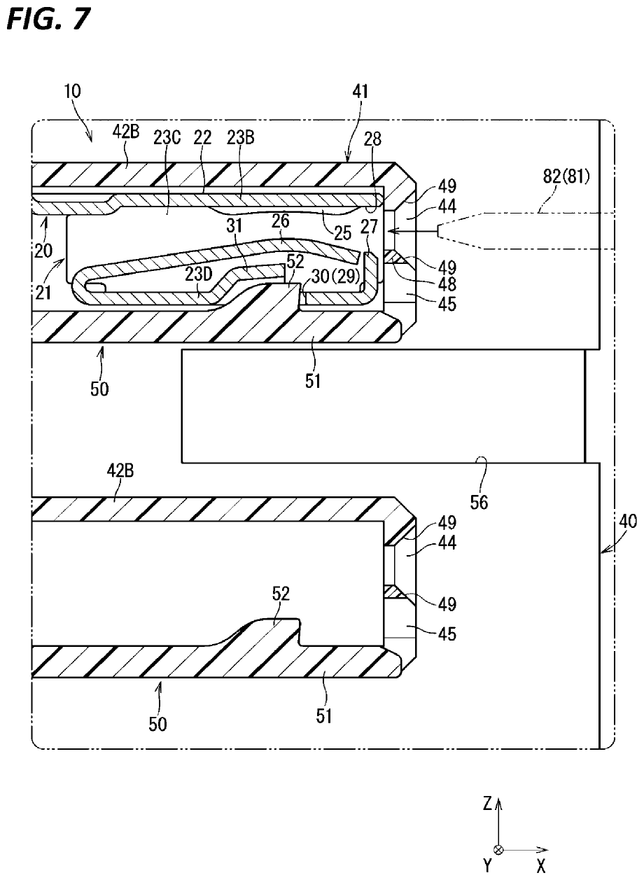

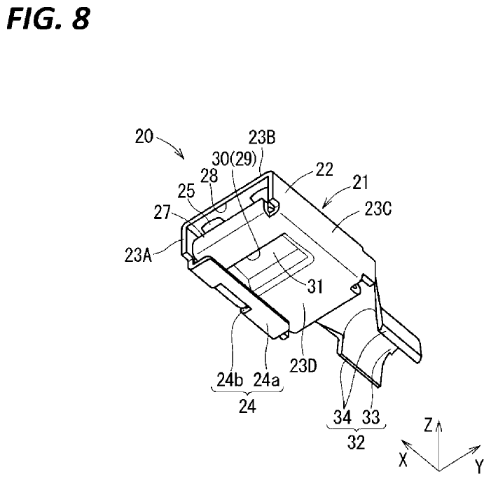

Hereinafter, a connector and a connector device according to an embodiment are described. FIG. 1 is a perspective view showing a connector 10 according to the embodiment. FIG. 2 is a front view of the connector 10 according to the embodiment. FIG. 3 is a section along of FIG. 2. FIG. 4 is a section along IV-IV of FIG. 2. FIG. 5 is a section along V-V of FIG. 2. FIG. 6 is an enlarged view of a region Al of FIG. 2. FIG. 7 is an enlarged view of a region A2 of FIG. 3. FIG. 8 is a perspective view showing a terminal 20.

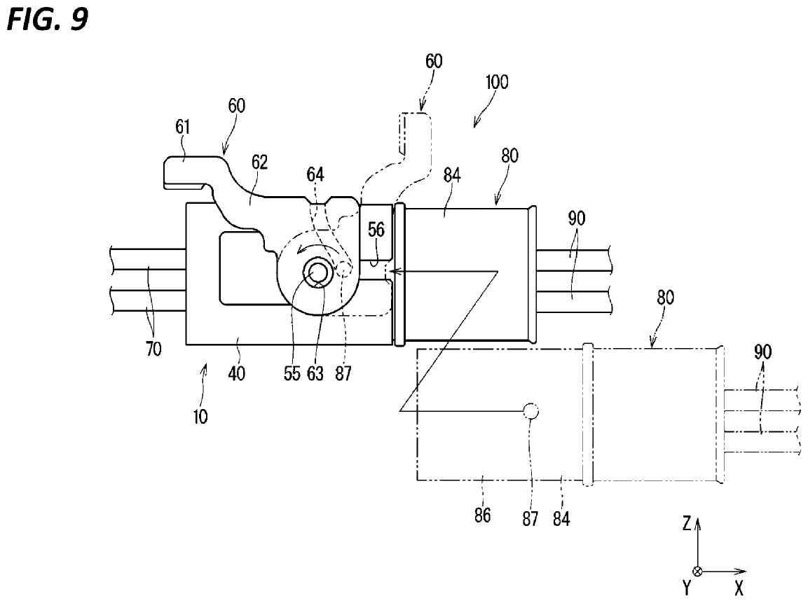

In the present disclosure, out of X, Y and Z directions orthogonal to each other, the X direction is referred to as a front-rear direction of the connector 10 as shown in FIG. 1. The X direction is also a connecting direction of the connector 10 and a mating connector 80. A side of the connector 10 near the mating connector 80 (see FIG. 9) is referred to as a front part, and an opposite side is referred to as a rear part. Each component of the connector 10 is described, using directions corresponding to the X, Y and Z directions in the case of a mounted state, even in an unmounted state.

The connector 10 is provided with the terminals 20 and a connector housing 40. The connector housing 40 includes terminal accommodating portions 41 and locking lances 50. The locking lance 50 locks and retains the terminal 20 accommodated in the terminal accommodating portion 41. Here, the connector 10 includes a lever 60. The connector 10 may not be provided with the lever 60.

The terminal 20 includes a connecting portion 21 and a wire connecting portion 32. The connecting portion 21 is formed into a so-called female terminal shape. The connecting portion 21 is provided by bending and deforming a conductive plate such as a metal plate. Here, one conductive plate is bent and deformed to form the terminal shape including the connecting portion 21 and the wire connecting portion 32.

The connecting portion 21 is connected to a mating terminal 81 in the mating connector 80. The connecting portion 21 includes a box portion 22, a resilient piece 26, a protecting piece 27 and a projecting piece 31. The connecting portion 21 is formed with a terminal-side opening 28 and a lock receiving portion 29.

The box portion 22 has four plate-like parts 23. Each of the four plate-like parts 23 extends in the front-rear direction. The box portion 22 is formed into a rectangular tube shape by the four plate-like parts 23. The terminal-side opening 28 is formed in the front end part of the box portion 22. As shown in FIG. 4, a tab portion 82 in the mating terminal 81 is inserted into the box portion 22 through the terminal-side opening 28.

The four plate-like parts 23 are connected about an axis along the X direction. If the four plate-like parts 23 need to be distinguished below, the four plate-like parts 23 may be called a first plate-like part 23A, a second plate-like part 23B, a third plate-like part 23C and a fourth plate-like part 23D from one end side toward the other end side in a circumferential direction. The first and third plate-like parts 23A, 23C are facing each other while expanding along an XZ plane. The second and fourth plate-like parts 23B, 23D are facing each other while expanding along an XY plane. Here, the second and fourth plate-like parts 23B, 23D are wider than the first and third plate-like parts 23A, 23C. In this way, the box portion 22 has a flat shape longer in the Y direction than in the Z direction.

The second plate-like part 23B is connected to the first and third plate-like parts 23A, 23C. The fourth plate-like part 23D is connected to the third plate-like part 23C, but not connected to the first plate-like part 23A. The first and fourth plate-like parts 23A, 23D are provided with a lock portion 24 for maintaining the shape of the box portion 22 obtained by bending the conductive plate. The lock portion 24 includes a lock piece 24a extending from the first plate-like part 23A and overlapped outside the fourth plate-like part 23D. A lock hole 24b is formed in a coupled part of the lock piece 24a and the first plate-like part 23A. The shape of the box portion 22 obtained by bending the conductive plate is maintained by inserting a tip part of the fourth plate-like part 23D into the lock hole 24b.

Inward protrusions 25 and a resilient piece 26 are provided inside the box portion 22. The inward protrusions 25 and the resilient piece 26 are provided to face each other. The inward protrusions 25 are provided on one of two plate-like parts 23 facing each other, out of the four plate-like parts 23, and the resilient piece 26 is provided on the other. Here, the inward protrusions 25 are provided on the second plate-like part 23B, and the resilient piece 26 is provided on the fourth plate-like part 23D.

The inward protrusions 25 project inwardly of the box portion 22 from the inner surface of the second plate-like part 23B. The inward protrusions 25 are formed by press-working parts of the second plate-like part 23B inwardly of the box portion 22 along a thickness direction. Thus, recesses corresponding to the inward protrusions 25 are formed in the outer surface of the second plate-like part 23B.

The resilient piece 26 extends forward from the rear end of the fourth plate-like part 23D. The resilient piece 26 is brought into contact with the tab portion 82 in the mating terminal 81. An intermediate part of the resilient piece 26 is closer to the second plate-like part 23B than a base end part and a tip part of the resilient piece 26. The intermediate part of the resilient piece 26 is resiliently deformable away from the second plate-like part 23B when contacting the tab portion 82.

An interval between the inward protrusions 25 and the resilient piece 26 before the tab portion 82 is inserted is smaller than a thickness of the tab portion 82. If being inserted into the box portion 22, the tab portion 82 presses the resilient piece 26. In this way, the resilient piece 26 is resiliently deformed to increase the interval between the inward protrusions 25 and the resilient piece 26. By this reaction force, the tab portion 82 is pressed toward the inward protrusions 25. In this way, the tab portion 82 is sandwiched by the inward protrusions 25 and the resilient piece 26 and a connected state of the terminal 20 and the mating terminal 81 is stabilized.

The protecting piece 27 extends from the front end of the fourth plate-like part 23D toward the terminal-side opening 28. The protecting piece 27 extends along the Z direction. A tip part of the protecting piece 27 covers the front end of the resilient piece 26 from front along the X direction. The tip part of the protecting piece 27 is located closer to the fourth plate-like part 23D than a part of the intermediate part of the resilient piece 26 closest to the second plate-like part 23B.

A housing-side opening 43 in the connector housing 40 is located in front of the terminal-side opening 28. The tab portion 82 of the mating terminal 81 passed through a first opening part 44 in the housing-side opening 43 is inserted into the terminal-side opening 28. Here, a part surrounded by the first, second and third plate-like parts 23A, 23B and 23C and the protecting piece 27 serves as the terminal-side opening 28. As shown in FIG. 6, when the terminal 20 is observed from front along the front-rear direction, the inward protrusions 25 and the intermediate part of the resilient piece 26 are exposed through the terminal-side opening 28.

The lock receiving portion 29 is provided on the fourth plate-like part 23D. A locking projection 52 of the locking lance 50 is locked to the lock receiving portion 29. The lock receiving portion 29 includes a recess 30 formed in the fourth plate-like part 23D. Here, the lock receiving portion 29 is provided below the part of the resilient piece 26 closest to the second plate-like part 23B.

The projecting piece 31 projects from a peripheral edge part of the recess 30 in the fourth plate-like part 23D. The projecting piece 31 is interposed between the locking projection 52 and the resilient piece 26. The projecting piece 31 is separated in the Z direction from the resilient piece 26 before the tab portion 82 is inserted. The projecting piece 31 is connected to the fourth plate-like part 23D behind the recess 30 along the X direction and on both lateral sides of the recess 30 along the Y direction on the peripheral edge part of the recess 30. The projecting piece 31 is not connected to the fourth plate-like part 23D in front of the recess 30 along the X direction on the peripheral edge part of the recess 30. The locking projection 52 of the locking lance 50 is locked to a part of the peripheral edge part of the recess 30 located in front of the recess 30 along the X direction and not connected to the projecting piece 31.

The wire connecting portion 32 is connected to a wire 70. The wire 70 is, for example, a coated wire including a core wire 71 and a coating layer 72. Here, the wire connecting portion 32 and the wire 70 is connected by crimping the wire connecting portion 32 to the wire 70. The wire connecting portion 32 includes a bottom portion 33 and a pair of crimping pieces 34. The bottom portion 33 extends rearward from the second plate-like portion 23B. The crimping pieces 34 extend in the Z direction from both sides of the bottom portion 33. By crimping the crimping pieces 34 to the core wire 71, the wire connecting portion 32 and the wire 70 are connected. However, the wire connecting portion 32 may be connected to the wire 70 by welding, insulation displacement or the like. Further, although the wire connecting portion 32 is not provided with crimping pieces to be crimped to the coating layer 72 here, crimping pieces to be crimped to the coating layer 71 may be provided in the wire connecting portion 32.

In the connector housing 40, a plurality of sets of the terminal accommodating portion 41 and the locking lance 50 are provided. Here, the connector housing 40 includes four terminal accommodating portions 41 and the locking lance 50 is provided in each of the four terminal accommodating portions 41.

For example, the connector housing 40 is an injection molded article using a material containing a resin. Here, the connector housing 40 is made of fiber reinforced plastic. The fiber reinforced plastic is a material mixed with a fiber as a filler for enhancing the strength of the resin. Such a fiber is not particularly limited and can be appropriately set. For example, the fiber is a glass fiber. Further, the resin is not particularly limited and can be appropriately set. For example, the resin is PBT (polybutylene terephthalate).

The terminal 20 is accommodated into each terminal accommodating portion 41. Note that the terminals 20 are not shown in FIGS. 3 to 7 in some terminal accommodating portions 41, out of the plurality of terminal accommodating portions 41, to show a state where the terminal 20 is accommodated in the terminal accommodating portion 41 and a state where the terminal 20 is not accommodated in the terminal accommodating portion 41.

The terminal accommodating portion 41 is in the form of a rectangular tube corresponding to the tab portion 22. The terminal accommodating portion 41 has four wall portions 42A, 42B, 42C and 42D respectively facing the four plate-like portions 23. Out of the four wall portions 42A, 42B, 42C and 42D, the first wall portion 42A faces the first plate-like portion 23A. Out of the four wall portions 42A, 42B, 42C and 42D, the second wall portion 42B faces the second plate-like portion 23B. Out of the four wall portions 42A, 42B, 42C and 42D, the third wall portion 42C faces the third plate-like portion 23C. Out of the four wall portions 42A, 42B, 42C and 42D, the fourth wall portion 42D faces the fourth plate-like portion 23D.

The housing-side opening 43 is formed in a front part of the terminal accommodating portion 41. The housing-side opening 43 includes the first opening part 44 and a second opening part 45. The first and second opening parts 44, 45 are arranged in the Z direction. Here, the first and second opening parts 44, 45 are completely partitioned when observed from the X direction.

The tab portion 82 of the mating terminal 81 is inserted into the first opening part 44. The shape of the first opening part 44 when viewed from the X direction is a shape in conformity with a transverse cross-sectional shape of the tab portion 82. Here, the shape of the first opening part 44 when viewed from the X direction is a rectangular shape longer in the Y direction than in the Z direction. A slope portion 49 is provided on a peripheral edge part of the first opening part 44. The slope portion 49 guides the tab portion 82 toward the inside of the first opening part 44.

The second opening part 45 receives an unlocking operation of the locking lance 50. The second opening part 45 is provided in an intermediate part in the Y direction and on a lower side in the Z direction. In the Y direction, the second opening part 45 is shorter than the first opening part 44. In the Z direction, the second opening part 45 is longer than the first opening part 44.

An opening through which the terminal 20 is inserted into the terminal accommodating portion 41 is formed in a rear part of the terminal accommodating portion 41. The terminal 20 is inserted into the terminal accommodating portion 41, for example, after being connected to the wire 70 to form a wire with terminal. A part of the wire 70 behind a part connected to the terminal 20 extends out from the terminal accommodating portion 41 through the opening in the rear part of the terminal accommodating portion 41.

A positioning wall portion 46 is provided on the front end of the terminal accommodating portion 41. The positioning wall portion 46 covers the front end of the terminal 20 from front while narrowing the housing-side opening 43. The positioning wall portion 46 includes a peripheral wall portion 47 and a partition wall portion 48. The slope portion 49 is provided on the positioning wall portion 46.

The peripheral wall portion 47 extends about an axis along the X direction. The peripheral wall portion 47 projects toward the inside of the terminal accommodating portion 41 from the front ends of the first, second, third and fourth wall portions 42A, 42B, 42C and 42D. The peripheral wall portion 48 covers the box portion 22 from front along the front-rear direction. For example, a projection dimension of the peripheral wall portion 47 from the inner surface of the first wall portion 42A is equal to or larger than a thickness of the conductive plate constituting the terminal 20 (thickness of the plate-like portion 23).

The partition wall portion 48 partitions between the first and second opening parts 44, 45. The partition wall portion 48 extends in the Y direction to connect the first and third wall portions 42A, 42C. The partition wall portion 48 covers a tip part of the protecting piece 27 from front. The partition wall portion 48 has a part constituted only by the slope portion 49 when observed from front along the front-rear direction. The second opening part 45 reaches the partition wall portion 48. A part of the slope portion 49 provided on the partition wall portion 48 is missing due to the second opening part 45.

As shown in FIG. 4, the locking lance 50 is provided on the fourth wall portion 42D. The locking lance 50 includes an extending piece 51 and a locking projection 52. Here, slits 42S are formed in parts of the fourth wall portion 42D and a part between the slits 42S serves as the extending piece 51. The extending piece 51 is in the form of a cantilever. In the X direction, a rear part of the extending piece 51 is connected to the fourth wall portion 42D. In the X direction, a front part of the extending piece 51 is a free end. In each of the Y and Z directions, the extending piece 51 is shorter than the second opening part 45. In the Y direction, a dimension of the extending piece 51 from the slit 42S on one side to the slit 42S on the other side is equal to a dimension of the second opening part 45.

The locking projection 52 projects toward the inside of the terminal accommodating portion 41 from the inner surface of the extending piece 51 in the Z direction. The locking projection 52 is provided in an intermediate part in the X direction of the extending piece 51. The locking projection 52 is provided behind the inner surface of the positioning wall portion 46 along the X direction. The front surface (surface facing forward along the X direction) of the locking projection 52 forms the peripheral edge part of the recess 30. The rear surface (surface facing rearward along the X direction) of the locking projection 52 serves as an inclined surface for guiding a part of the terminal 20 forward of the recess 30 at the time of insertion of the terminal 20 into the terminal accommodating portion 41. In the Z direction, a dimension from the outer surface of the extending piece 51 to the inner surface of the locking projection 52 is shorter than the dimension of the second opening part 45.

As shown in FIG. 6, a part of the terminal 20 around the terminal-side opening 28 in a region including the locking projection 52 is exposed through the second opening part 45 when observed from the front of the connector housing 40 along the front-rear direction. For example, the region including the locking projection 52 is a region of a forward projected part of the locking projection 52. Here, a base end part of the protecting piece 27 is exposed through the second opening part 45 in the region including the locking projection 52 when observed from the front of the connector housing 40 along the front-rear direction.

As shown on a right side of FIG. 6, the entire locking projection 52 is exposed through the second opening part 45 when observed from the front of the connector housing 40 along the front-rear direction in a state where the terminal 20 is absent in the terminal accommodating portion 41. A peripheral edge part of the second opening part 45 is partially shaped to correspond to the outer edge of the locking projection 52 when observed from the front of the connector housing 40 along the front-rear direction in the state where the terminal 20 is absent in the terminal accommodating portion 41. The peripheral edge part of the second opening part 45 and the outer edge of the locking projection 52 are separated. In this way, the locking lances 50 are easily removed from a mold in the front-rear direction in molding the connector housing 40 using the mold.

The front end of the locking lance 50 in the front-rear direction is located between the front end of the terminal 20 and that of the terminal accommodating portion 41. The front end of the locking lance 50 in the front-rear direction is located between the inner and outer surfaces of the positioning wall portion 46 in the X direction. Here, the front end of the extending piece 51 in the front-rear direction is the front end of the locking lance 50.

The front end of the locking lance 50 in the front-rear direction is located at the same position as or behind that of the terminal accommodating portion 41. In this way, it is suppressed that the front end of the locking lance 50 projects further forward than the front end of the terminal accommodating portion 41 and the locking lance 50 is excessively deflected.

The front end of the locking lance 50 in the front-rear direction is located at the same position as or in front of that of the terminal 20. In this way, a gap of the second opening part 45 is smaller as compared to the case where the front end of the locking lance 50 in the front-rear direction is located behind that of the terminal 20. In this way, it is suppressed that a finger of a worker or the like touches the terminal 20 through the gap of the second opening part 45.

Four terminal accommodating portions 41 are arranged in the Y and Z directions. The four terminal accommodating portions 41 are arranged in two rows and in two stages. Rear parts of the fourth terminal accommodating portions 41 are connected to each other. Front parts of the four terminal accommodating portions 41 are separated from each other. In the front parts of the terminal accommodating portions 41, an interval between two terminal accommodating portions 41 in the Z direction is larger than that between two terminal accommodating portions 41 in the Y direction.

As shown in FIG. 3, one of the two terminal accommodating portions 41 arranged in the Z direction is referred to as a first terminal accommodating portion 41A, and the other is referred to as a second terminal accommodating portion 41B. Rear parts of the first and second terminal accommodating portions 41A, 41B are connected to each other. Front parts of the first and second terminal accommodating portions 41A, 41B are separated from each other. The locking lance 50 provided in the first terminal accommodating portion 41A is facing the second terminal accommodating portion 41B.

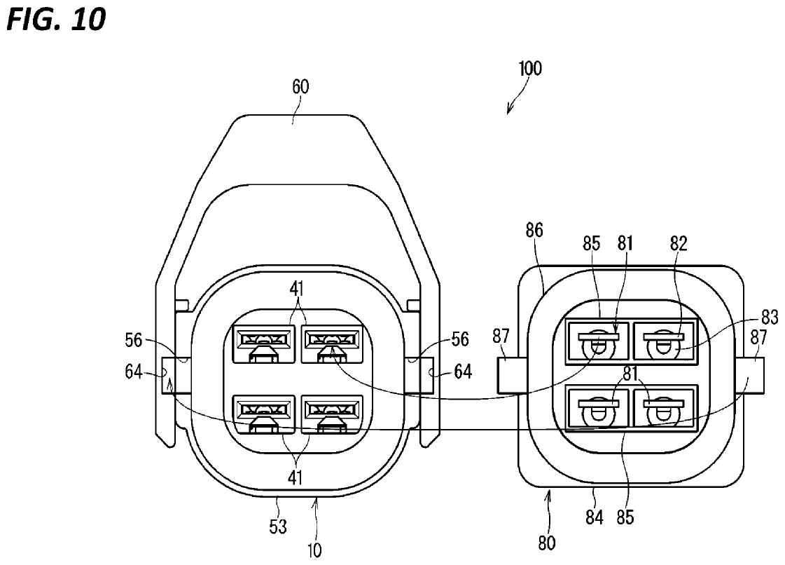

As shown in FIG. 1, the connector housing 40 includes a receptacle 53 surrounding the terminal accommodating portions 41. Housing-side mounting portions 54 are provided on the outer surface of the receptacle 53. The lever 60 is mounted on the housing-side mounting portions 54. The housing-side mounting portion 54 includes a shaft portion 55. Further, the receptacle 53 is formed with slits 56. The slits 56 are formed in front of the housing-side mounting portions 54. The slits 56 extend toward the housing-side mounting portions 54 along the X direction from a peripheral edge part of a front opening in the receptacle 53. As shown in FIGS. 9 and 10, outward protrusions 87 provided on the mating connector 80 are inserted into the slits 56.

The lever 56 is a component for reducing a connection force of the connector 10 and the mating connector 80 by rotating. The lever 60 is provided on the connector housing 40. The lever 60 is a component molded separately from the connector housing 40. The lever 60 is mounted on the connector housing 40. The lever 60 includes a lever body 61 and lever-side mounting portions 62.

The lever body 61 is a part for receiving an operation of the worker. The lever-side mounting portions 62 are provided on both sides of the lever body 61. The lever-side mounting portions 62 are mounted on the housing-side mounting portions 54. The lever 60 is mounted rotatably with respect to the connector housing 40. Here, the lever-side mounting portion 62 is provided with a bearing portion 63. The shaft portion 55 is rotatably supported in the bearing portion 63. A groove 64 is formed in the inner surface of the lever-side mounting portion 62. The outward protrusion 87 provided on the mating connector 80 is inserted into the groove 64. The groove 64 extends around the bearing portion 63. The groove 64 is so shaped that the outward protrusion 87 is inserted to the back of the groove 64 while approaching the bearing portion 63 as the lever 60 is rotated with respect to the connector housing 40.

### Connector Device 100

FIG. 9 is a side view showing a connector device 100. FIG. 10 is a view showing connection surfaces of the connector 10 and the mating connector 80. In FIG. 9, solid lines show a state where the connector 10 and the mating connector 80 are connected, and two-dot chain lines show the lever 60 and the mating connector 80 before connection.

The connector device 100 is provided with the connector 10 and the mating connector 80 to be connected to the connector 10. The mating connector 80 includes the mating terminals 81 and a mating connector housing 84. The mating terminal 81 is formed into a male terminal shape including the tab portion 82. Here, the mating terminal 81 includes a mating wire connecting portion 83. The mating wire connecting portion 83 is connected to a mating wire 90. The mating connector housing 84 includes mating terminal accommodating portions 85, a mating receptacle 86 and the outward protrusions 87. The mating terminals 81 are accommodated into the mating terminal accommodating portions 85. The mating receptacle 86 surrounds the mating terminal accommodating portions 85. The mating receptacle 86 is inserted into the receptacle 53. The outward protrusions 87 are provided on the outer surface of the mating receptacle 86. The outward protrusions 87 are inserted into the grooves 64 of the lever 60 through the slits 56 of the receptacle 53.

With the connector 10 and the mating connector 80 connected, the wires 70 and the mating wires 90 are connected via the terminals 20 and the mating terminals 81. At this time, the connector housing 40 of the connector 10 and the mating connector housing 84 of the mating connector 80 are facing each other in the front-rear direction.

### Effects

According to the connector 10 and the connector device 100 configured as described above, the front end of the locking lance 50 is located at the same position as or behind that of the terminal accommodating portion 41 in the front-rear direction, thereby suppressing that the locking lance 50 projects further forward than the terminal accommodating portion 41 and the locking lance 50 is excessively deflected. Further, since the part of the terminal 20 around the terminal-side opening 28 is exposed through the second opening part 45 in the region including the locking projection 52 when observed from the front of the connector housing 40 along the front-rear direction, the shape of a mold is simplified in the case of injection-molding the locking lance 50 when the connector housing 40 is molded using the mold. In this case, since the front end of the locking lance 50 is located at the same position as or in front of that of the terminal 20 in the front-rear direction, a gap formed around the front end of the locking lance 50 becomes smaller and touch on the terminal 20 through this gap is suppressed.

Further, the front end of the terminal accommodating portion 41 is provided with the positioning wall portion 46 for covering the front end of the terminal 20 from front while narrowing the housing-side opening 43. In this way, the terminal 20 is suppressed from coming out forward from the terminal accommodating portion 41 through the housing-side opening 43 by the positioning wall portion 46.

Further, the tip part of the protecting piece 27 covers the front end of the resilient piece 26 from front and the base end part of the protecting piece 27 is exposed through the second opening part 45 when observed from the front of the connector housing 40 along the front-rear direction. In this way, when the tab portion 82 of the mating terminal 81 is inserted into the first opening part 44 and the terminal-side opening 28, the contact of the tab portion 82 with the front end of the resilient piece 26 is suppressed by the protecting piece 27. Further, when the locking lance 50 is unlocked, the contact of a member for unlocking the locking lance 50 with the front end of the resilient piece 26 is suppressed by the protecting piece 27.

Further, the lock receiving portion 29 includes the recess 30 formed in the plate-like part 23, and the connecting portion 21 includes the projecting piece 31 projecting from the peripheral edge part of the recess 30, out of the plate-like part 23, and interposed between the locking projection 52 and the resilient piece 26. In this way, the contact of the resilient piece 26 with the locking projection 52 is suppressed by the projecting piece 31. Particularly, the resilient piece 26 is pushed by the tab portion 82 and deformed toward the locking projection 52 here. Also in this case, the contact of the deformed resilient piece 26 with the locking projection 52 is suppressed by the projecting piece 31.

The positioning wall portion 46 of the terminal accommodating portion 41 includes the partition wall portion 48 partitioning between the first and second opening parts 44, 45, and the partition wall portion 48 covers the tip part of the protecting piece 27 from front. In this way, when the tab portion 82 is inserted through the first opening part 44 and the terminal-side opening 28, the tab portion 82 is less likely to be caught by the peripheral edge parts of the first opening part 44 and the terminal-side opening 28.

Further, the slope portion 49 for guiding the tab portion 82 toward the inside of the first opening part 44 is provided on the peripheral edge part of the first opening part 44, and the partition wall portion 48 has the part constituted only by the slope portion 49. In this way, the first and second opening parts 44, 45 can be close to each other, and the enlargement of the connector housing 40 can be suppressed.

Further, the connector housing 40 is made of reinforced fiber plastic. In this way, the strength of the connector housing 40 can be increased and the partition wall portion 48 between the first and second opening parts 44, 45 can be made thinner.

Further, the locking lance 50 provided in the first terminal accommodating portion 41A is facing the second terminal accommodating portion 41B. In this way, a wall for suppressing excessive deflection of the locking lance 50 outside the locking lance 50 is omitted in the first terminal accommodating portion 41A, whereby the structure of the connector housing 40 is simplified and the enlargement of the connector housing 40 is suppressed.

Further, the connector housing 40 of the connector 10 and the mating connector housing 84 of the mating connector 80 are facing each other in the front-rear direction. In this way, the connector housing 40 of the connector 10 and the mating connector housing 84 of the mating connector 80 are connected in the front-rear direction without via a front mask, front retainer or the like, whereby the enlargement of the connector device 100 is suppressed.

### Addenda

Although the connector housing 40 provided with the positioning wall portions 46 have been described thus far, this is not essential. The connector housing 40 may not be provided with the positioning wall portions 46. Even if the connector housing 40 is provided with the positioning wall portions 46, the configuration of the positioning wall portions 46 is not limited to the one described above. For example, either one of the peripheral wall portion 47 and the partition wall portion 48 may not be provided in the positioning wall portion 46. Further, for example, the partition wall portion 48 may be provided below the tip part of the protecting piece 27. Further, for example, the partition wall portion 48 may not be provided with the part constituted only by the slope portion 49.

Further, although it has been described thus far that the tip part of the protecting piece 27 covers the front end of the resilient piece 26 from front and the base end part of the protecting piece 27 is exposed through the second opening part 45 when observed from the front of the connector housing 40 along the front-rear direction, this is not essential. For example, the protecting piece 27 may not be provided in the terminal 20.

Further, although the connecting portion 21 including the projecting piece 31 has been described thus far, this is not essential. The connecting portion 21 may not include the projecting piece 31.

Further, although it has been described thus far that the locking lance 50 provided in the first terminal accommodating portion 41A is facing the second terminal accommodating portion 41B, this is not essential. For example, a member such as a front retainer or front mask for suppressing the deflection of the locking lance 50 may be interposed between the locking lance 50 provided in the first terminal accommodating portion 41A and the second terminal accommodating portion 41B.

Note that the respective components described in the embodiment and the respective modifications can be appropriately combined as long as these components do not contradict each other.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a terminal including a connecting portion to be connected to a mating terminal; and
a connector housing including a terminal accommodating portion for accommodating the terminal and a locking lance for locking the terminal accommodated in the terminal accommodating portion,
a housing-side opening being formed in a front part of the terminal accommodating portion,
the housing-side opening including a first opening part, a tab portion of the mating terminal being inserted into the first opening part, and a second opening part for receiving an unlocking operation of the locking lance,
the locking lance including a locking projection,
the connecting portion being formed with a terminal-side opening, the tab portion passed through the first opening part being inserted into the terminal-side opening, and a lock receiving portion to be locked by the locking projection,
a part of the terminal around the terminal-side opening being exposed through the second opening part in a region including the locking projection when observed from front of the connector housing along a front-rear direction, and
a front end of the locking lance in the front-rear direction being located at the same position as or in front of that of the terminal and located at the same position as or behind that of the terminal accommodating portion.

2. The connector of claim 1, wherein a positioning wall portion for covering the front end of the terminal from front while narrowing the housing-side opening is provided on the front end of the terminal accommodating portion.

3. The connector of claim 2, wherein:
the connecting portion is provided by bending and deforming a conductive plate,
the connecting portion includes a plate-like part extending in the front-rear direction, a resilient piece extending forward from a rear end of the plate-like part and to be brought into contact with the tab portion, and a protecting piece extending toward the terminal-side opening from a front end of the plate-like part,
a tip part of the protecting piece covers a front end of the resilient piece from front, and
a base end part of the protecting piece is exposed through the second opening part when observed from the front of the connector housing along the front-rear direction.

4. The connector of claim 3, wherein:
the lock receiving portion includes a recess formed in the plate-like part, and
the connecting portion includes a projecting piece projecting from a peripheral edge part of the recess, out of the plate-like part, and interposed between the locking projection and the resilient piece.

5. The connector of claim 3, wherein:
the positioning wall portion of the terminal accommodating portion includes a partition wall portion partitioning between the first opening part and the second opening part, and
the partition wall portion covers the tip part of the protecting piece from front.

6. The connector of claim 5, wherein:
a slope portion for guiding the tab portion toward inside of the first opening part is provided on the peripheral edge part of the first opening part, out of the positioning wall portion, and
the partition wall portion has a part constituted only by the slope portion.

7. The connector of claim 1, wherein:
the connector housing includes a first terminal accommodating portion and a second terminal accommodating portion,
a rear part of the first terminal accommodating portion and that of the second terminal accommodating portion are connected to each other,
a front part of the first terminal accommodating portion and that of the second terminal accommodating portion are separated from each other, and
the locking lance provided in the first terminal accommodating portion is facing the second terminal accommodating portion.

8. A connector device, comprising:
the connector of claim 1; and
a mating connector to be connected to the connector,
the connector housing of the connector and a connector housing of the mating connector being facing each other in the front-rear direction in a connected state.
